(19) United States
(12) Patent Application Publication
(10) Pub. No.: US 2012/0109527 A1
(43) Pub. Date: May 3, 2012

(54) Apparatus and Methods for Drilling Wellbores by Ranging Existing Boreholes Using Induction Devices

(75) Inventors: Alexandre N. Bespalov, Spring, TX (US); Assol Kavtokina, Spring, TX (US)

(73) Assignee: BAKER HUGHES INCORPORATED, Houston, TX (US)

(21) Appl. No.: 13/234,476

(22) Filed: Sep. 16, 2011

Related U.S. Application Data
(60) Provisional application No. 61/383,949, filed on Sep. 17, 2010.

(51) Int. Cl. G06F 19/00; G01V 3/10

(52) U.S. Cl. 702/7; 324/339

(57) ABSTRACT

In one aspect a method of drilling a borehole is disclosed, wherein the method includes generating a primary electromagnetic field with a transmitter in a second borehole spaced from the first borehole, the primary electromagnetic filed causing electrical current in the conductive material of the first borehole, measuring a secondary electromagnetic field at a receiver in the second borehole, the electromagnetic field being responsive to the electrical current flowing in the conductive material in the first borehole, and determining a location of the first borehole using the measured secondary electromagnetic field.

### CROSS REFERENCE TO RELATED APPLICATIONS

The present application claims priority from U.S. Provisional Application Ser. No. 61/383,949, filed Sep. 17, 2010.

### BACKGROUND OF THE DISCLOSURE

1. Field of the Disclosure

The present disclosure relates to apparatus and methods for detecting and ranging a first borehole from a second borehole.

2. Description of the Related Art

In oil exploration, it is sometimes desired to drill a new borehole in proximity to another borehole which has been previously drilled, sometimes referred to as a reference borehole. When such a new borehole is being drilled, it is important to determine the distance to the reference borehole, direction towards the reference borehole, and mutual orientation of the boreholes so as to prevent collision of the boreholes. It also may be desirable, in some applications, to drill the new borehole at a certain distance from the reference borehole or alongside or parallel to the reference borehole.

A completed reference borehole typically has a metal pipe inserted therein as a casing. Metal pipes are highly conductive and respond to electromagnetic activities from various electromagnetic devices, such as magnetic induction coils in a measurement-while-drilling device in drill string conveyed for drilling the wellbore. The response of these metal pipes to magnetic induction may therefore be used to locate and range the reference borehole for use in steering the drill string along a desired path. The disclosure herein provides apparatus and methods for the detection ranging of an existing borehole and using such information for drilling of boreholes.

### SUMMARY OF THE DISCLOSURE

In one aspect a method of detection and ranging is disclosed, wherein the method includes generating a primary electromagnetic field with a transmitter in a second borehole spaced from the first borehole, the primary electromagnetic field causing electrical current in the conductive material of the first borehole, measuring a secondary electromagnetic field from this current at a receiver in the second borehole, the secondary electromagnetic field being responsive to the electrical current flowing in the conductive material in the first borehole, and determining a location of the first borehole using the measured secondary electromagnetic field.

In another aspect, an apparatus for detection and ranging of a first borehole having a conductive member therein is disclosed, wherein the apparatus in one configuration includes a transmitter configured to generate a primary electromagnetic field when the transmitter is in a second borehole to cause an electrical current in the conductive member in the first borehole, a receiver configured to measure a secondary electromagnetic field when the receiver is in the second borehole, the secondary electromagnetic field being responsive to the electrical current flowing in the conductive member in the first borehole, and a processor configured to determine a location of the first borehole using the measured secondary electromagnetic field.

Examples of certain features of the apparatus and method disclosed herein are summarized rather broadly in order that the detailed description thereof that follows may be better understood. There are, of course, additional features of the apparatus and method disclosed hereinafter that will form the subject of the claims.

### BRIEF DESCRIPTION OF THE DRAWINGS

For detailed understanding of the present disclosure, references should be made to the following detailed description of the preferred embodiment, taken in conjunction with the accompanying drawings, in which like elements have been given like numerals and wherein:

FIG. 1 is a schematic illustration of an exemplary drilling system suitable for using an apparatus made according to various embodiments of this disclosure for drilling boreholes according to the methods described herein;

FIG. 2 shows two exemplary spaced apart boreholes drilled in a formation, according to one method of the disclosure;

FIG. 3 shows a coordinate system of a general geometrical configuration of a new borehole being drilled with respect to a reference borehole, according to one aspect of the disclosure;

FIG. 4A shows a cross-sectional view of a borehole being drilled with respect to remote pipes located at various angular locations; and

FIG. 4B shows magnitude and sign of a cross-component magnetic signal S_{XY} versus rotation angle.

### DETAILED DESCRIPTION OF THE DISCLOSURE

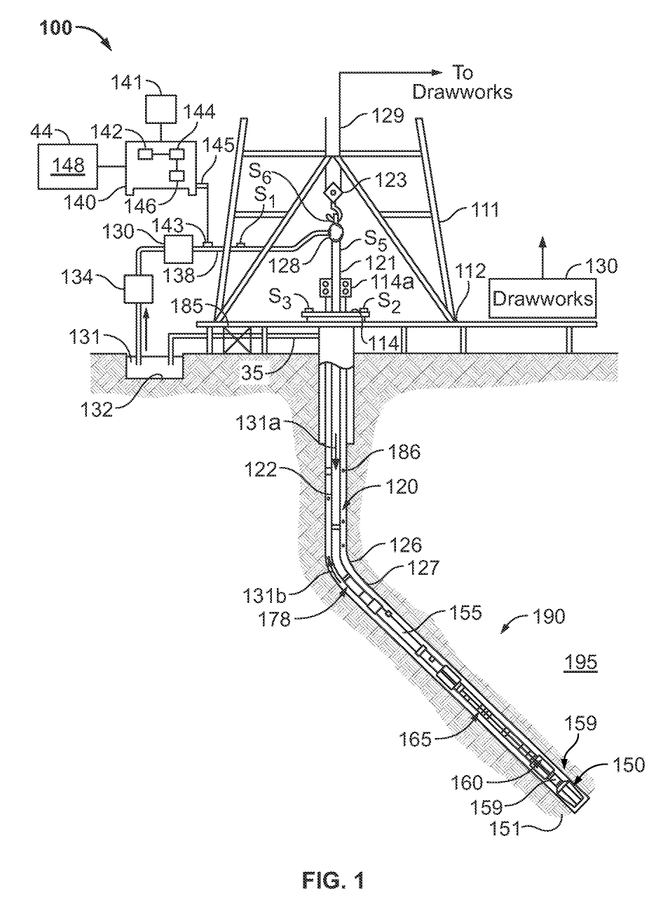

FIG. 1 is a schematic diagram of an exemplary drilling system 100 that includes a drill string having a drilling assembly attached to its bottom end that includes a steering unit according to one embodiment of the disclosure. FIG. 1 shows a drill string 120 that includes a drilling assembly or bottomhole assembly (“BHA”) 190 conveyed in a borehole 126. The drilling system 100 includes a conventional derrick 111 erected on a platform or floor 112 which supports a rotary table 114 that is rotated by a prime mover, such as an electric motor (not shown), at a desired rotational speed. A tubing (such as jointed drill pipe) 122, having the drilling assembly 190 attached at its bottom end extends from the surface to the bottom 151 of the borehole 126. A drill bit 150, attached to drilling assembly 190, disintegrates the geological formations when it is rotated to drill the borehole 126. The drill string 120 is coupled to a draw-works 130 via a Kelly joint 121, swivel 128 and line 129 through a pulley. Draw-works 130 is operated to control the weight on bit (“WOB”). The drill string 120 may be rotated by a top drive (not shown) instead of by the prime mover and the rotary table 114. The operation of the draw-works 130 is known in the art and is thus not described in detail herein.

In an aspect, a suitable drilling fluid 131 (also referred to as “mud”) from a source 132 thereof, such as a mud pit, is circulated under pressure through the drill string 120 by a mud pump 134. The drilling fluid 131 passes from the mud pump 134 into the drill string 120 via a desurger 136 and the fluid line 138. The drilling fluid 131a from the drilling tubular discharges at the borehole bottom 151 through openings in the drill bit 150. The returning drilling fluid 131b circulates uphole through the annular space 127 between the drill string 120 and the borehole 126 and returns to the mud pit 132 via a return line 135 and drill cutting screen 185 that removes the drill cuttings 186 from the returning drilling fluid 131b. A sensor S₁ in line 138 provides information about the fluid flow rate. A surface torque sensor S₂ and a sensor S₃ associated with the drill string 120 provide information about the torque and the rotational speed of the drill string 120. Rate of penetration of the drill string 120 may be determined from the sensor S₅, while the sensor S₆ may provide the hook load of the drill string 120.

In some applications, the drill bit 150 is rotated by rotating the drill pipe 122. However, in other applications, a downhole motor 155 (mud motor) disposed in the drilling assembly 190 also rotates the drill bit 150. The rate of penetration (“ROP”) for a given drill bit and BHA largely depends on the WOB or the thrust force on the drill bit 150 and its rotational speed.

A surface control unit or controller 140 receives signals from the downhole sensors and devices via a sensor 143 placed in the fluid line 138 and signals from sensors S₁-S₆ and other sensors used in the system 100 and processes such signals according to programmed instructions provided from a program to the surface control unit 140. The surface control unit 140 displays desired drilling parameters and other information on a display/monitor 141 that is utilized by an operator to control the drilling operations. The surface control unit 140 may be a computer-based unit that may include a processor 142 (such as a microprocessor), a storage device 144, such as a solid-state memory, tape or hard disc, and one or more computer programs 146 in the storage device 144 that are accessible to the processor 142 for executing instructions contained in such programs. The surface control unit 140 may further communicate with a remote control unit 148. The surface control unit 140 may process data relating to the drilling operations, data from the sensors and devices on the surface, data received from downhole and may control one or more operations of the downhole and surface devices.

The drilling assembly 190 also contain formation evaluation sensors or devices (also referred to as measurement-while-drilling, “MWD,” or logging-while-drilling, “LWD,” sensors) determining resistivity, density, porosity, permeability, acoustic properties, nuclear-magnetic resonance properties, corrosive properties of the fluids or formation downhole, salt or saline content, and other selected properties of the formation 195 surrounding the drilling assembly 190. Such sensors are generally known in the art and for convenience are generally denoted herein by numeral 165. The drilling assembly 190 may further include a variety of other sensors and communication devices 159 for controlling and/or determining one or more functions and properties of the drilling assembly (such as velocity, vibration, bending moment, acceleration, oscillations, whirl, stick-slip, etc.) and drilling operating parameters, such as weight-on-bit, fluid flow rate, pressure, temperature, rate of penetration, azimuth, tool face, drill bit rotation, etc.

Still referring to FIG. 1, the drill string 120 further includes energy conversion devices 160 and 178. In an aspect, the energy conversion device 160 is located in the BHA 190 to provide an electrical power or energy, such as current, to sensors 165 and/or communication devices 159. Energy conversion device 178 is located in the drill string 120 tubular, wherein the device provides current to distributed sensors located on the tubular. As depicted, the energy conversion devices 160 and 178 convert or harvest energy from pressure waves of drilling mud which are received by and flow through the drill string 120 and BHA 190. Thus, the energy conversion devices 160 and 178 utilize an active material to directly convert the received pressure waves into electrical energy. As depicted, the pressure pulses are generated at the surface by a modulator, such as a telemetry communication modulator, and/or as a result of drilling activity and maintenance. Accordingly, the energy conversion devices 160 and 178 provide a direct and continuous source of electrical energy to a plurality of locations downhole without power storage (battery) or an electrical connection to the surface.

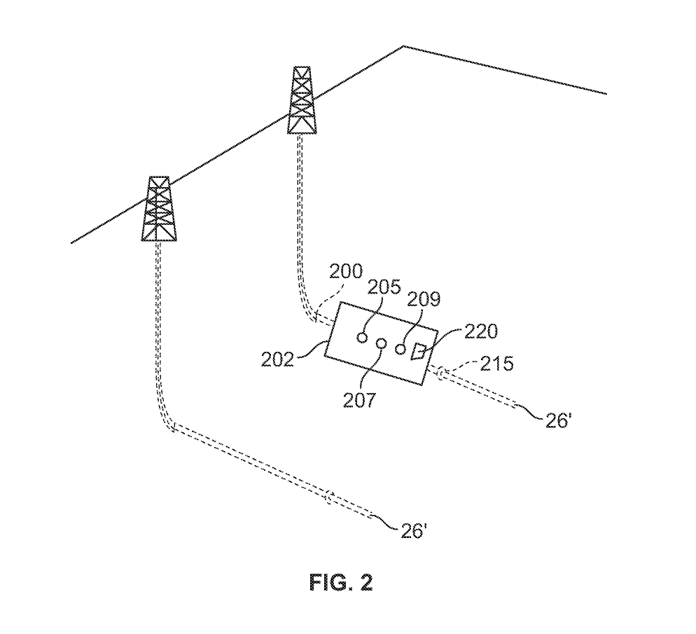

FIG. 2 shows a reference (first) borehole 226 with a new (second) borehole 226′ being drilled at a laterally displaced location from the reference borehole 226. In FIG. 2, the two boreholes 226 and 226′ are shown being drilled from two different rigs, but they may also be drilled using the same rig. The second borehole 226′ contains a drill string 200 having a sensing tool, such as a magnetic induction tool 202 having various antenna coils 205, 207 and 209. The antenna coils 205, 207 and 209 may be used to locate the first borehole 226 when the first borehole 226 is within a range to be affected by an electromagnetic field produced in the second borehole 226′. In one embodiment the antenna coils 205, 207 and 209 include multi-axial transmitter and receiver coils that induce and measure electromagnetic fields, respectively. In one embodiment, the antenna coils are oriented along X, Y and Z directions, wherein the Z direction is along the longitudinal axis of the drill string 200. In an exemplary magnetic induction tool 202, coil 205 is an X-oriented transmitter coil 205 and coils 207 and 209 are Y- and Z-oriented receiver coils, respectively. However, the axial locations of transmitter and receiver coils in the magnetic induction tool 202 are not limited to a particular configuration. In addition, coils may serve as both transmitter and receiver coils. Magnetic fields measured at the induction tool 202 are referred to herein by S_{MN} wherein M is the orientation of the transmitter coil and N is the orientation of the receiver coil. Therefore, a signal S_{XY} refers to a measured signal received at a Y-oriented receiver coil in response to a magnetic field produced at an X-oriented transmitter coil. Typically, signals S_{XX}, S_{YY}, and S_{ZZ} are referred to as principal components and exemplary signals S_{XY}, S_{XZ}, S_{YZ}, S_{YX}, S_{ZX}, and S_{ZY} are referred to as cross components.

In one aspect, the transmitter coil 205 of magnetic induction tool 202 in the second borehole 226′ produces a primary electromagnetic field which induces an electrical current in a the first borehole 226 via interaction of the produced electromagnetic field with a conductive material within the first borehole 226, such as a metal casing or pipe. Since the distance between the magnetic induction tool and the pipe is much greater than the diameter of the pipe, such a casing or pipe may be considered as a long, thin and very conductive straight line. An electromagnetic field produced by the induced electrical current at the first borehole 226 is measured at receivers 207 and 209 at the magnetic induction tool 202.

A processor such as a downhole processor 220 coupled to the magnetic induction tool 202 determines various parameters from the measured magnetic fields. In various aspects, the determined parameters are used to perform various drilling functions using the steering unit of the BHA. Exemplary drilling functions include: determining an approaching collision between the drill string and the first borehole; steering the drill string to avoid a collision; estimating a distance between drill string and the first borehole and their mutual orientation; and drilling a second borehole parallel to the first borehole. Additionally, the processor may perform calculations to correct for a skin effect. Since detection and ranging of the first borehole are based on electromagnetically inducing an electric current along the remote pipe, energizing or magnetization of the remote pipe is not required. In one embodiment, the magnetic induction tool 202 is located proximate a drill bit 215, thereby improving the accuracy and relevancy of obtained measurements to the drill bit location, which is useful when detecting a collision condition.

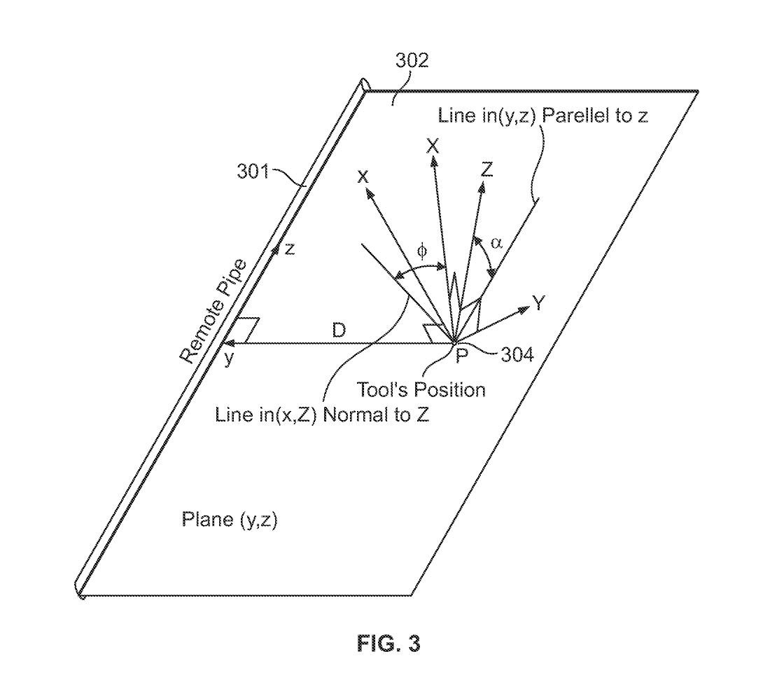

FIG. 3 shows a coordinate system of a general geometrical configuration of an induction tool of a second borehole 226′ being drilled with respect to a first borehole 226. Formation 302 is generally considered to be homogeneous and isotropic. In one aspect, the first borehole 226 includes a conductive casing or pipe 301. FIG. 3 shows two coordinate systems (x,y,z) and (X,Y,Z). Coordinate system (x,y,z) is the coordinate system of the pipe 301 of the first borehole and has the z-direction along the longitudinal axis of the remote pipe. The y-direction is indicated as the direction from an induction tool's position P 304 to the nearest pipe point. Therefore, y is orthogonal to z. The x-direction is orthogonal to both y- and z-directions. Coordinate system (X,Y,Z) is the coordinate system of the induction tool 202 located in the second borehole and is centered at point P 304, where Z is the longitudinal (drilling) direction of a drill string passing through point P 304 and X and Y are rotating axes orthogonal to each other and to Z. For the purpose of explaining the concepts described herein, transmitters and receivers of the magnetic induction tool are considered to be collocated at point P 304.

Plane (y,z) refers to a plane passing through the point P 304 and parallel to the directions y and z. Therefore, plane (y,z) is the plane containing the magnetic induction tool's current position P and a line indicative of the remote pipe. Angle α is the angle between the drilling direction Z and the plane (y,z). Plane (x,Z) refers to a plane passing through the point P and parallel to the directions x and Z. Angle φ is the angle between the direction X and the plane (x,Z). Since X and Y coils rotate with the rotation of the induction tool, angle φ therefore is the rotation phase angle of the magnetic induction tool.

Various aspects for using the measured second electromagnetic fields in drilling the second borehole are now discussed. In one aspect, the measured second electromagnetic fields may be used to determine an approaching collision between a drill string in a second borehole and a conductive pipe in a first borehole. Cross-signals S_{XY} and S_{XZ} may be used to determine distance and orientation of the induction tool with respect to the conductive pipe of the first borehole. S_{XY} and S_{XZ} are functions of the projections of the antenna directions onto x and the angles α and φ:

$${S}_{XY} = {S}_{0} {M}_{X} {M}_{Y} {cos}^{2} α sin φcos φ = {S}_{0} {M}_{X} {M}_{Y} {cos}^{2} α \frac{sin 2 φ}{2} \qquad Eq . ( 1 )$$

S_{XZ}=S₀M_{X}M_{Z} cos α sin α cos φ Eq. (2)

where M_{X}, M_{Y}, and M_{Z} are the effective magnetic moments of the X, Y, and Z-antennas and S₀ is a function depending on pipe parameters, formation resistivity, distance to the pipe, and on operational frequency. S₀ is approximated by Eq. (3):

$${S}_{0} \approx {C}_{pipe} {R}_{t}^{- 1 / 2} {D}^{- 2} {ω}^{2} exp ( - \frac{2 D}{{L}_{skin}} ) , \\ where {L}_{skin} = \sqrt{\frac{2 {R}_{t}}{{ωμ}_{0}}} \qquad Eq . ( 3 )$$

where Cₚᵢₚₑ is a constant depending on the pipe parameters, such as conductivity, inner and outer diameters, etc., Rₜ is a formation resistivity, D is a perpendicular distance between the magnetic induction tool (point P 304) and the conductive pipe of the first borehole, and ω is the angular operational frequency. It follows from Eqs. (1) and (2) that:

$$α = arctan \frac{{M}_{Y} {max}_{φ} \vert {S}_{XZ} \vert}{2 {M}_{Z} {max}_{φ} \vert {S}_{XY} \vert} \qquad Eq . ( 4 )$$

Therefore, Eq. (4) may be used to determine angle α by comparing the maximums of the cross-signals measured during rotation and thereby to determine the possibility of a collision of the second borehole with the first borehole. If angle α is close to zero, then the current drilling direction is substantially coplanar with the reference borehole and the drill string is either parallel to the reference borehole, approaching it, or going away from it. This direction within the plane can be determined by monitoring S_{XY}. If the signal S_{XY} is constant, then the drilling direction is parallel to the remote pipe. If the signal S_{XY} is increasing, then the drill string is approaching the pipe and further drilling (in the same direction) will lead to a collision. If the signal S_{XY} is decreasing, the drill string is going away from the pipe.

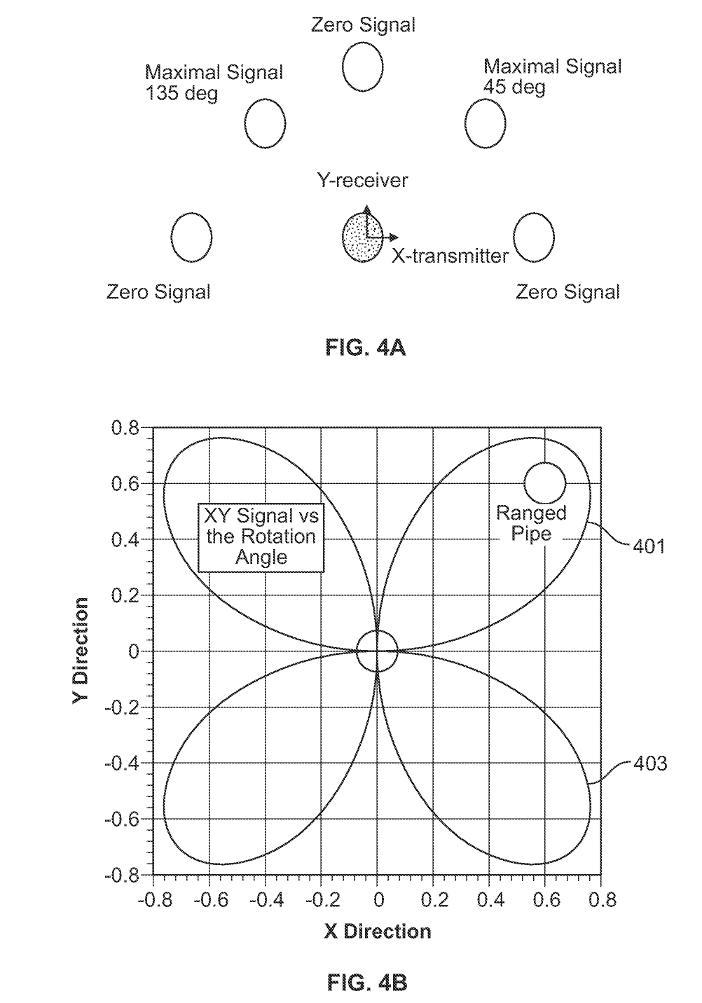

In another aspect, the measured electromagnetic fields can be used to steer a drill string to avoid an approaching collision with a first borehole. For coplanar drilling, when the Y direction is coplanar with plane (y,z), collision can be avoided by steering along the X direction (normal to the (y,z) plane). The X-direction is generally determined from measuring the magnitude of S_{XZ}. However, although S_{XZ} is a maximum when Y is coplanar with (y,z), since max_{φ}|S_{XZ}| is typically close to zero in this situation, it is hard to detect. Instead, the X-direction may be determined and the drill string steered using the signal S_{XY}, as illustrated with respect to FIGS. 4A-B.

FIG. 4A shows a cross-sectional view of an exemplary borehole with remote pipes located at various angular locations. The magnitude of S_{xy} is maximal when the angle between the X-direction and the (y,z) plane is φ=45° and 135°. Two planes satisfy this condition, and they are orthogonal to each other. The X-direction can be determined once a sign associated with each plane is determined. FIG. 4B shows the magnitude of S_{XY} versus the rotation angle and signs (positive or negative) associated with lobes 401 and 403 at various angles. Lobe 401 has a positive sign and lobe 403 has a negative sign. The sign of the lobes can be determined from the signs of the real and/or imaginary part of the signal and then used to yield an unambiguous X-direction for steering purposes.

In another aspect, the measured second electromagnetic fields can be used to detect and range a conductive pipe of a first borehole using a skin effect. Due to the dependence of Lₛₖᵢₙ on formation resistivity, the detection range quickly decreases with decreasing formation resistivity Rₜ. Signal magnitude attenuation depends on the operational frequency ω non-monotonically. For each value of Rₜ and D, there exists an optimal value of the frequency at which the signal is a maximum. Based on Eq. (3), this maximum signal occurs for a frequency that produces Lₛₖᵢₙ=D/2. For example, if D=10 m and Rₜ=100 ohmm, the optimal frequency is about 1 MHz. A typical desired drilling distance between new borehole and reference borehole is about 5 meters. Therefore, a typical operating range for the magnetic induction tool is from 100 kHz to 1 MHz. In one aspect, the magnetic induction tool may be operated at multiple frequencies. Additionally, the magnetic induction tool may be swept over a range of frequencies. Frequencies may be selected to minimize or control the effects of the skin-effect on measured signals.

In another aspect, the processor corrects for effects related to skin-effect attenuation and skin depth. From Eq. (3), when the distance D is comparable to the skin-depth Lₛₖᵢₙ, the sign of right-hand side of Eq. (3) may flip from positive to negative. A calculation that does not consider skin effect can lead to an incorrect reading of direction and thus to steering towards a pipe rather than away from the pipe. The sign flip due to skin effect can be corrected using Eq. (3) based on known values of S₀ and Rₜ. Skin effects can be corrected using Eq. (3) calibrated for Cₚᵢₚₑ or by looking values up on a table, such as a table of S₀ versus Rₜ and D. S₀ is typically known from the measurements. The value of formation resistivity Rₜ is typically obtained using an additional measurement.

In another aspect, the measured fields are used to drill a second borehole parallel to a first borehole, in particular to reorient a drill string back into the (y,z) plane when the drill string deviates from the plane, producing a nonzero angle α. In such an instance, signal S_{XY} may be used to provide a direction normal to plane (y,z) and signal S_{XZ} can be used to differentiate between a normal pointing towards the plane (y,z) and a normal pointing away from plane (y,z), thereby enabling steering of the drill string back into plane (y,z). In various aspects, the signs of the real and/or imaginary parts of S_{XZ} are used in determining the direction of the normal.

Alternative coil configurations of the magnetic induction tool may be used. In one exemplary embodiment, non-collocated antenna coils are used on the magnetic induction tool, with the processor correcting for the effect of non-collocated coils using standard symmetrization procedures, such as described in Eqs. (6) and (7). An exemplary symmetric coil configuration uses a set of non-collocated antennas which includes one X-transmitter, two Y-receivers and two Z-receivers placed symmetrically with respect to the X-transmitter. Received signals S_{XY}^{left} and S_{XY}^{right}, which indicate measurements obtained at Y-receiver coils to the left and right, respectively, of the X-transmitter coil, can be combined using Eq. (6):

$${S}_{XY} = \frac{{S}_{XY}^{left} + {S}_{XY}^{right}}{2} \qquad Eq . ( 6 )$$

Similarly received signals S_{XZ}^{left} and S_{XZ}^{right} can be combined using Eq. (7):

$${S}_{XZ} = \frac{{S}_{XZ}^{left} + {S}_{XZ}^{right}}{2} \qquad Eq . ( 7 )$$

Therefore, values obtained using Eqs. (6) and (7) may considered to be centered at reference point P, wherein point P is the position of the X-transmitter. In various embodiments, standard bucking methods may be used to suppress nonzero cross-signals that are due to eccentricity of the magnetic induction tool in a borehole.

In another exemplary coil configuration, a receiver oriented at 45° to the Y and Z axes can be used in place of two separate Y- and Z-receivers. Signals S_{XY} and S_{XZ} can then be obtained from measurements of the receiver coil oriented at 45° by Fourier analysis since different harmonics are obtained with respect to the rotational phase φ. Additionally, Fourier analysis and subtraction of a mean value may be used to filter out anomalies due to misalignment of antennas, etc. In yet another exemplary coil configuration, all transmitters and receivers may be swapped—basing on the reciprocity principle.

Processing of the data may be done by a downhole processor to give corrected measurements substantially in real time. Implicit in the control and processing of the data is the use of a computer program on a suitable machine readable medium that enables the processor to perform the control and processing. The machine readable medium may include ROMs, EPROMs, EEPROMs, Flash Memories and Optical disks.

Thus, in one aspect a method of drilling a borehole is disclosed that in one configuration includes: inducing a primary electromagnetic field generated by a transmitter in a second borehole spaced from the first borehole, the primary electromagnetic filed causing electrical current in the conductive material of the first borehole, measuring a secondary electromagnetic field at a receiver in the second borehole, the secondary electromagnetic field being responsive to the electrical current flowing in the conductive material in the first borehole, and determining a location of the first borehole using the measured electromagnetic field. In one aspect, the primary magnetic field may be induced using a transmitter induction coil oriented transverse to a longitudinal axis of a drilling assembly in the second borehole. In another aspect, the secondary electromagnetic field may be measured at a first receiver induction coil oriented along the longitudinal axis of the drilling assembly and a second receiver induction coil oriented orthogonal to the longitudinal axis of the drilling assembly and to the transmitter induction coil. In yet another aspect, the method may further include steering the drilling assembly substantially parallel to the first borehole using the determined location of the first borehole. In one aspect, the drilling assembly may be steered into a coplanar path with the first borehole using the measured secondary electromagnetic fields. In another aspect, the drilling assembly may be steered to avoid a collision with the first borehole. In yet another aspect, the method may further include operating one of a transmitter and a receiver coil at one of: (i) a single frequency, (ii) multiple frequencies, and (iii) sweeping across a range of frequencies. In yet another aspect, the method may further include correcting the measured secondary electromagnetic field for a skin effect using the skin effect to determine the location of the first borehole. In yet another aspect, the method may further include measuring the secondary electromagnetic field at a coil oriented at 45° to the longitudinal axis of a drilling assembly in the second borehole. In yet another aspect, all transmitters and receivers may be swapped—basing on the reciprocity principle.

In another aspect an apparatus for drilling a borehole in relation to first borehole having a conductive member therein is disclosed. In one configuration, such an apparatus includes a transmitter configured to generate a primary electromagnetic field when the transmitter is in a second borehole to cause an electrical current in the conductive member of the first borehole, a receiver configured to measure an electromagnetic field when the receiver is in the second borehole, the secondary electromagnetic field being responsive to the electrical current flowing in the conductive member in the first borehole, and a processor configured to determine a location of the first borehole using the measured secondary electromagnetic field.

While the foregoing disclosure is directed to the preferred embodiments of the disclosure, various modifications will be apparent to those skilled in the art. It is intended that all variations within the scope and spirit of the appended claims be embraced by the foregoing disclosure.

1. A method of drilling a borehole, comprising:
inducing electrical current in a conductive member in a first borehole by generating a primary electromagnetic field with a transmitter in a second borehole spaced from the first borehole;
measuring a secondary electromagnetic field at a receiver in the second borehole that is responsive to the electrical current flowing in the conductive material in the first borehole; and
determining a location of the first borehole using the measured secondary electromagnetic field.

2. The method of claim 1, wherein generating the primary electromagnetic field comprises using a transmitter induction coil for generating the primary electromagnetic field.

3. The method of claim 2, wherein the transmitter induction coil is carried by a drilling assembly deployed in the second borehole, the method further comprising orienting the transmitter induction coil transverse to a longitudinal axis of the drilling assembly, deployed in the second borehole.

4. The method of claim 2, wherein measuring the secondary electromagnetic field comprises measuring the secondary electromagnetic field at one of: (i) a receiver induction coil oriented along a longitudinal axis of a drilling assembly in the second borehole; (ii) a receiver induction coil oriented orthogonal to a longitudinal axis of a drilling assembly and to the transmitter induction coil.

5. The method of claim 1 further comprising steering a drilling assembly substantially parallel to the first borehole using the determined location of the first borehole.

6. The method of claim 1 further comprising steering a drilling assembly into a coplanar path with the first borehole using the measured electromagnetic field.

7. The method of claim 1 further comprising steering a drilling assembly to avoid a collision with the first borehole.

8. The method of claim 1 further comprising operating one of the transmitter and the receiver at one of: (i) a single frequency; (ii) multiple frequencies; (iii) sweeping across a range of frequencies.

9. The method of claim 1 further comprising correcting the measured second magnetic field for a skin effect.

10. The method of claim 1, wherein determining a location of the first borehole further comprises using a skin effect.

11. The method of claim 5 further comprising measuring the secondary electromagnetic field at a coil oriented 45 degrees to the longitudinal axis of a drilling assembly in the second borehole.

12. A drilling assembly, comprising:
a transmitter configured to generate a primary electromagnetic field in first borehole to generate an electrical current in the conductive member in a second borehole that is spaced apart from the first borehole;
a receiver configured to measure a secondary electromagnetic field responsive to the current generated in the conductive member in the second borehole; and
a processor configured to determine a location of the first borehole using the measured secondary electromagnetic field.

13. The drilling assembly of claim 12, wherein the transmitter comprises a transmitter induction coil.

14. The drilling assembly of claim 13, wherein the transmitter induction coil is oriented transverse to a longitudinal axis of the drilling assembly.

15. The drilling assembly of claim 12, wherein the receiver comprises a receiver induction coil.

16. The drilling assembly of claim 15, wherein the receiver induction coil is oriented about 45 degrees to a longitudinal axis of the drilling assembly.

17. The apparatus of claim 15, wherein the receiver induction coil is oriented as one of: (i) along a longitudinal axis of a drilling assembly; (ii) orthogonal a longitudinal axis of the drilling assembly and orthogonal to a transmitter induction coil.

18. The drilling assembly of claim 12 further comprising steering device configured to steer the drilling assembly during drilling of a wellbore by the drilling assembly, wherein the processor is further configured to steer the drilling assembly substantially parallel to the first borehole using the determined location of the first borehole.

19. The apparatus of claim 12 further comprising a circuit configured to operate on of the transmitter and the receiver at one of: (i) a single frequency; (ii) multiple frequencies; and (iii) sweeping across a range of frequencies.

20. The drilling assembly of claim 12, wherein the processor is further configured to correct the measured second magnetic field for a skin effect.
